(19) United States
(12) Patent Application Publication
(10) Pub. No.: US 2018/0174728 A1
(43) Pub. Date: Jun. 21, 2018

(54) ELECTRICAL DEVICE WITH FLEXIBLE CONNECTORS

(71) Applicant: Hamilton Sundstrand Corporation, Charlotte, NC (US)

(72) Inventors: Charles Patrick Shepard, DeKalb, IL (US); Shin Katsumata, Rockford, IL (US)

(21) Appl. No.: 15/379,631

(22) Filed: Dec. 15, 2016

(51) Int. Cl. H01F 17/06; H01F 27/28; H01F 27/29

(52) U.S. Cl. CPC H01F 17/062; H01F 2027/2814; H01F 27/29; H01F 27/2804

(57) ABSTRACT

An electrical device includes a first flexible connector, including a first flexible conductor and a second flexible conductor, and a flexible insulator disposed between the first flexible conductor and the second flexible conductor, a second flexible connector spaced apart from the first flexible connector, the second flexible connector including a third flexible conductor, a first interconnect to electrically connect the first flexible conductor and the third flexible conductor, a second interconnect to electrically connect the third flexible conductor and the second flexible conductor, wherein the second interconnect is disposed opposite the first interconnect.

### BACKGROUND

The subject matter disclosed herein relates to electrical devices, and more particularly, to electrical devices that utilize flexible connectors.

Electrical devices such as transformers and inductors are utilized in many applications to convert power and filter input and output signals. Transformers and inductors require numerous electrical conductors in a desired arrangement to provide the desired functionality. Often, creating and arranging the numerous electrical conductors is expensive and difficult.

### BRIEF SUMMARY

According to an embodiment, an electrical device includes a first flexible connector, including a first flexible conductor and a second flexible conductor, and a flexible insulator disposed between the first flexible conductor and the second flexible conductor, a second flexible connector spaced apart from the first flexible connector, the second flexible connector including a third flexible conductor, a first interconnect to electrically connect the first flexible conductor and the third flexible conductor, a second interconnect to electrically connect the third flexible conductor and the second flexible conductor, wherein the second interconnect is opposite the first interconnect.

According to an embodiment an electrical device includes a first printed wiring board including a first interconnect, a second printed wiring board including a second interconnect, a first flexible connector disposed between the first printed wiring board and the second printed wiring board, the first flexible connector including a first flexible conductor and a second flexible conductor, and a flexible insulator disposed between the first flexible conductor and the second flexible conductor, a second flexible connector spaced apart from the first flexible connector and disposed between the first printed wiring board and the second printed wiring board, the second flexible connector including a third flexible conductor, wherein the first interconnect electrically connects the first flexible conductor and the third flexible conductor, and the second interconnect electrically connects the third flexible conductor and the second flexible conductor, wherein the second interconnect is opposite the first interconnect.

Technical function of the embodiments described above includes a first interconnect to electrically connect the first flexible conductor and the third flexible conductor, a second interconnect to electrically connect the third flexible conductor and the second flexible conductor, wherein the second interconnect is opposite the first interconnect.

Other aspects, features, and techniques of the embodiments will become more apparent from the following description taken in conjunction with the drawings.

### BRIEF DESCRIPTION OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the FIGURES:

FIG. 1A is an isometric view of an embodiment of an electrical device assembly;

FIG. 1B is an isometric view of the electrical device assembly of FIG. 1A with the upper printed wiring board removed;

FIG. 1C is a cross sectional view of the electrical device assembly of FIG. 1A;

FIG. 2 is an isometric view of a lower printed wiring board for use with the electrical device assembly of FIG. 1A;

FIG. 3 is an isometric view of an upper printed wiring board for use with the electrical device assembly of FIG. 1A;

FIG. 4 is an isometric view of a flexible connector for use with the electrical device assembly of FIG. 1A; and

FIG. 5 is a cross sectional view of an embodiment of an electrical device assembly.

### DETAILED DESCRIPTION

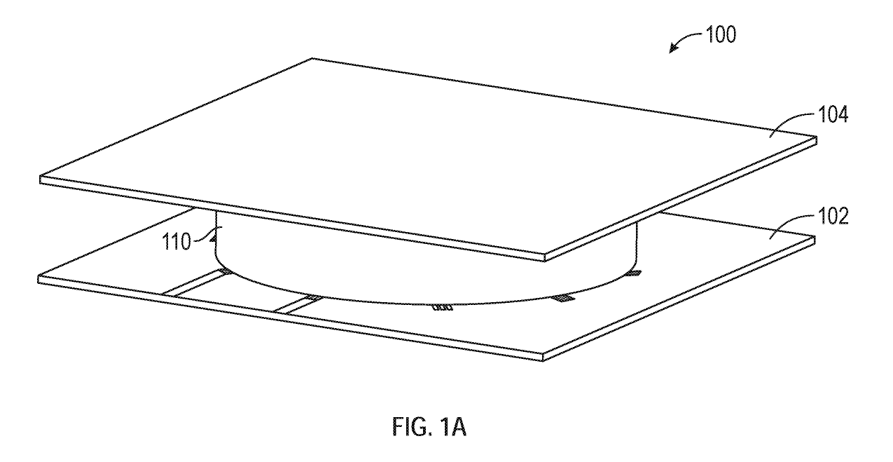

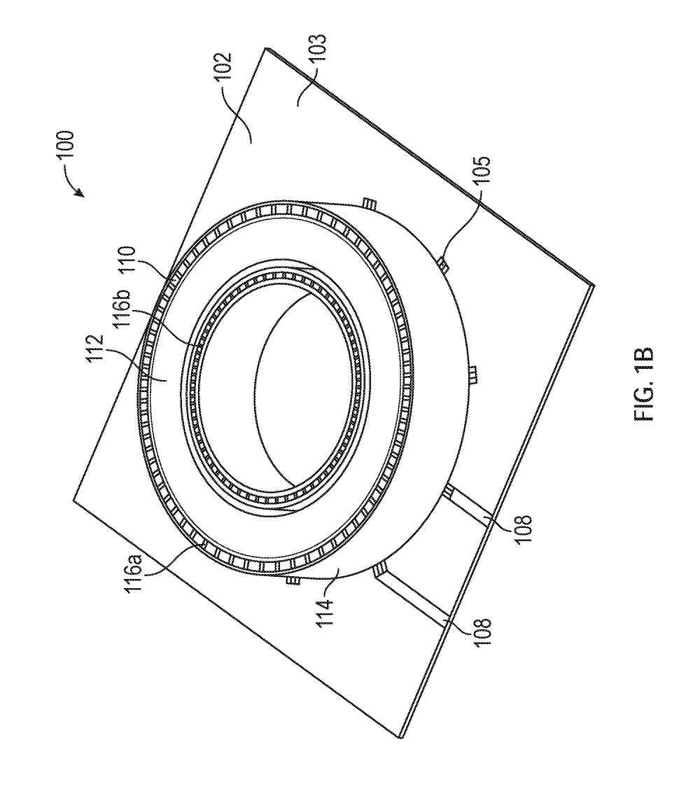

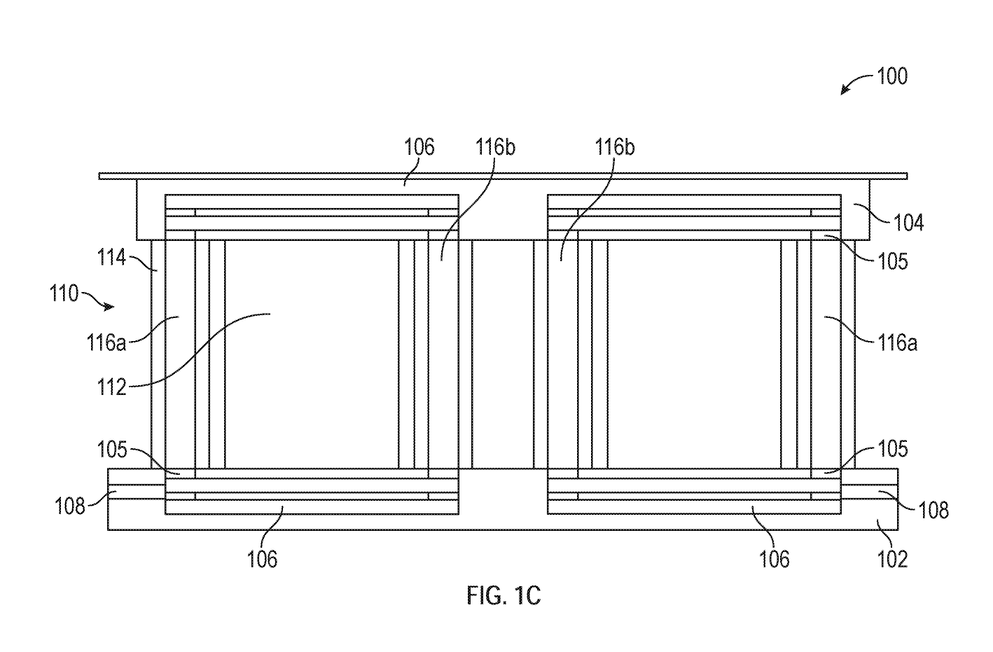

Referring to the drawings, FIGS. 1A-1C show an electrical device assembly 100. In the illustrated embodiment, the electrical device assembly 100 includes a lower printed wiring board 102, an upper printed wiring board 104, and a connector assembly 110. In the illustrated embodiment, the electrical device assembly 100 can be configured to operate as an inductor, transformer, etc. In the illustrated embodiment, the electrical device assembly 100 is shown as an inductor to filter input and output signals. Advantageously, the use of the connector assembly 110 allows for electrical connections needed for operation to be simplified.

In the illustrated embodiment, the electrical device assembly 100 allows for electrical connections to be formed in a desired arrangement. In the illustrated embodiment, the electrical device assembly 100 includes insulation barriers 114, an outer flexible connector 116a, a device core 112, and an inner flexible connector 116b. In the illustrated embodiment, the electrical device assembly 100 can be any suitable shape, including, but not limited to toroid shaped, etc.

In the illustrated embodiment, the outer flexible connector 116a and the inner flexible connector 116b are spaced apart with a device core 112 disposed therebetween. In the illustrated embodiment, the device core 112 is a solid core formed from any suitable material, including, but not limited to ferromagnetic materials. In certain embodiments, the device core 112 is an air core. Further, in the illustrated embodiment, insulation barriers 114 can be disposed around the outer flexible connector 116a and the inner flexible connector 116b to prevent unintended electrical connections within the electrical device assembly 100 and provide structural support.

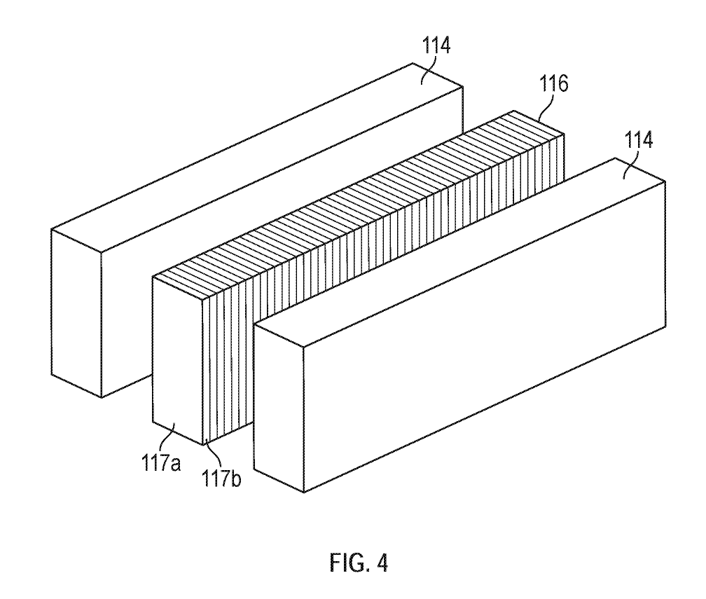

In the illustrated embodiment, electricity can flow within the flexible connectors 116a, 116b in a desired path to allow for a desired function, such as an inductor, transformer, etc. Referring to FIG. 4, each of the flexible connectors, generally referred to as flexible connector 116, includes alternating flexible conductors 117a and flexible insulators 117b. Advantageously, the flexible connector 116 provides a unitary body containing a plurality of flexible conductors 117a, allowing for conductive paths to be selectively created as desired quickly and inexpensively. Further, by utilizing flexible conductors 117a and flexible insulators 117b, the flexible connector 116 can withstand vibrations.

Referring back to FIGS. 1A-1C, the electrical device assembly 100 is disposed between the lower printed wiring board 102 and the upper wiring board 104. In the illustrated embodiment, the printed wiring boards 102,104 support and facilitate electrical connections through the electrical device assembly 100 to allow functionality as an inductor, transformer, etc.

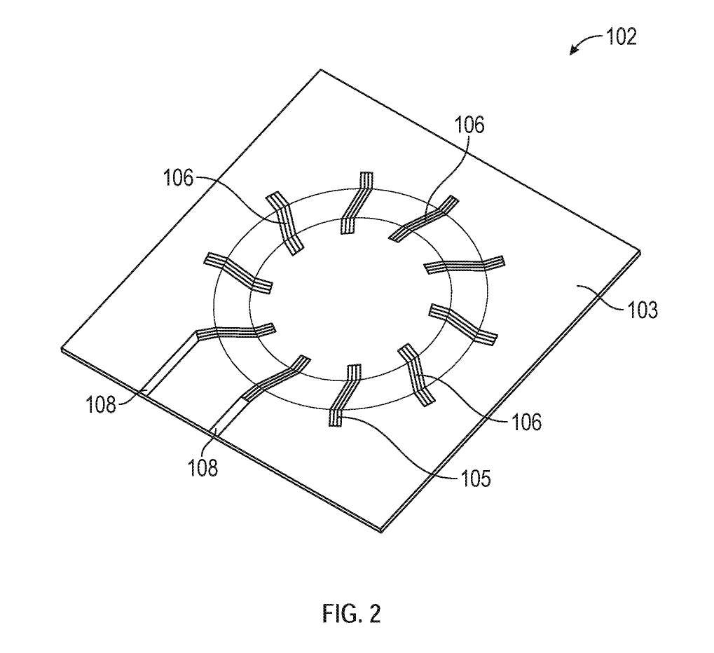

Referring to FIGS. 1A-2, the lower printed wiring board 102 is shown. In the illustrated embodiment, the lower printed wiring board 102 includes contact pads 105, interconnects 106, and input/output traces 108. In the illustrated embodiment, the lower printed wiring board 102 is formed from any suitable printed wiring board material 103, including, but not limited to copper sheets laminated onto a non-conductive substrate.

In the illustrated embodiment, conductive interconnects 106 can be formed within the lower printed wiring board 102. The conductive interconnects 106 can be copper conductive pathways. In the illustrated embodiment, the interconnects 106 are embedded within the lower printed wiring board 102 and are otherwise insulated. In the illustrated embodiment, ends of the interconnect 106 include contact pads 105 that are formed on the surface of the lower printed wiring board 102. In the illustrated embodiment, the interconnect 106 allows electrical contact between one contact pad 105 and the opposite contact pad 105 on the opposite end of the interconnect 106. In the illustrated embodiment, the contact pads 105 and the interconnects 106 allow for electrical contact between conductors of the outer flexible connector 116a and the inner flexible connector 116b.

In the illustrated embodiment, the contact pads 105 are aligned with the conductors within the flexible connectors 116a, 116b to allow electrical contact between the conductors within the outer flexible connector 116a and the inner flexible connector 116b.

In the illustrated embodiment, input/output traces 108 can provide electricity into and out of the electrical device assembly 100. In the illustrated embodiment, the input/output traces 108 are electrically connected to select interconnects 106 to allow for electricity to flow through a desired path through the connector assembly 110.

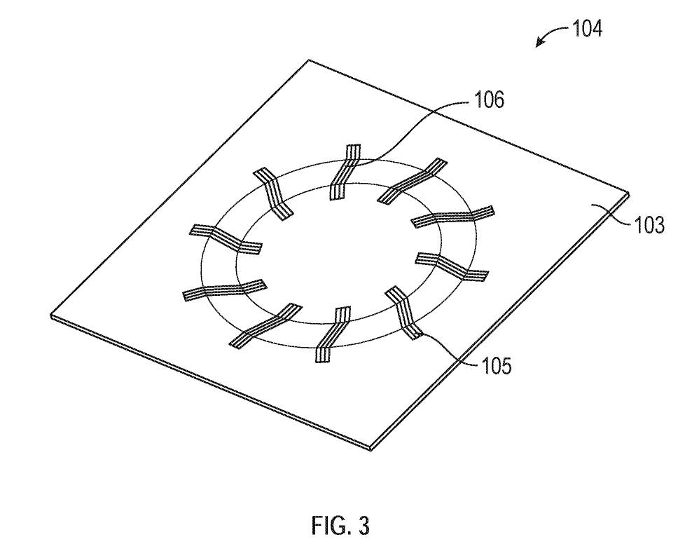

Referring to FIGS. 1A-C and FIG. 3, the upper printed wiring board 104 is shown. In the illustrated embodiment, the upper printed wiring board 104 includes contact pads 105 and interconnects 106. In the illustrated embodiment, the upper printed wiring board 104 is formed from any suitable printed wiring board material 103, including, but not limited to copper sheets laminated onto a non-conductive substrate.

In the illustrated embodiment, conductive interconnects 106 can be formed within the upper printed wiring board 104. The conductive interconnects 106 can be copper conductive pathways. In the illustrated embodiment, the interconnects 106 are embedded within the upper printed wiring board 104 and are otherwise insulated. In the illustrated embodiment, ends of the interconnect 106 include contact pads 105 that are formed on the surface of the upper printed wiring board 104. In the illustrated embodiment, the contact pads 105 allow electrical contact between one contact pad 105 and the opposite contact pad 105 on the opposite end of the interconnect 106. In the illustrated embodiment, the contact pads 105 and the interconnects 106 allow for electrical contact between conductors within the outer flexible connector 116a and the inner flexible connector 116b.

In the illustrated embodiment, the contact pads 105 are aligned with the conductors within the flexible connectors 116a, 116b to allow electrical contact between the conductors within the outer flexible connector 116a and the inner flexible connector 116b.

Referring to FIG. 1C, in the illustrated embodiment, the lower printed wiring board 102 and the upper printed wiring board 104 facilitate desired electrical connections through the flexible connectors 116a,116b to allow the electrical device assembly 100 to function as desired. In the illustrated embodiment, the configuration of the lower printed wiring board 102, the upper printed wiring board 104, and the flexible connectors 116a, 116b allows for a coiled electrical path to allow for functionality as an inductor.

For example, in the illustrated embodiment, electrical current can flow into the electrical device assembly 100 via the input/output trace 108, wherein the input/output trace 108 is connected to an interconnect 106 (I_{Lower}) disposed within the lower printed wiring board 102. In the illustrated embodiment, the contact pad 105 and the interconnect 106 (I_{Lower}) are aligned within the lower printed wiring board 102 with the outer flexible connector 116a to allow a flexible conductor 117a (FIG. 4) (C_{Outer1}) of the outer flexible conductor 116a to be electrically connected to the interconnect 106 (I_{Lower}) within the lower printed wiring board 102. In the illustrated embodiment, the interconnect 106 (I_{Lower}) is further electrically connected to the opposite contact pad 105, wherein the opposite contact pad 105 is aligned with a flexible conductor 117a (C_{Inner1}) of the inner flexible connector 116b.

Similarly, in the illustrated embodiment, the contact pad 105 and the interconnect 106 (I_{Upper}) within the upper printed wiring board 104 are aligned with the inner flexible connector 116b to allow the flexible conductor 117a (FIG. 4) (C_{Inner1}) to be electrically connected to the interconnect 106 (T_{Upper}) within the upper printed wiring board 104. In the illustrated embodiment, the interconnect 106 (T_{Upper}) is electrically connected with the opposite contact pad 105, wherein the opposite contact pad 105 is aligned with the next or adjacent flexible conductor 117a (C_{Outer2}) of the outer flexible connector 116a. Advantageously, this allows for a coil type power flow path without expensive and complex wiring configurations. In other embodiments, any suitable power flow path configuration can be utilized.

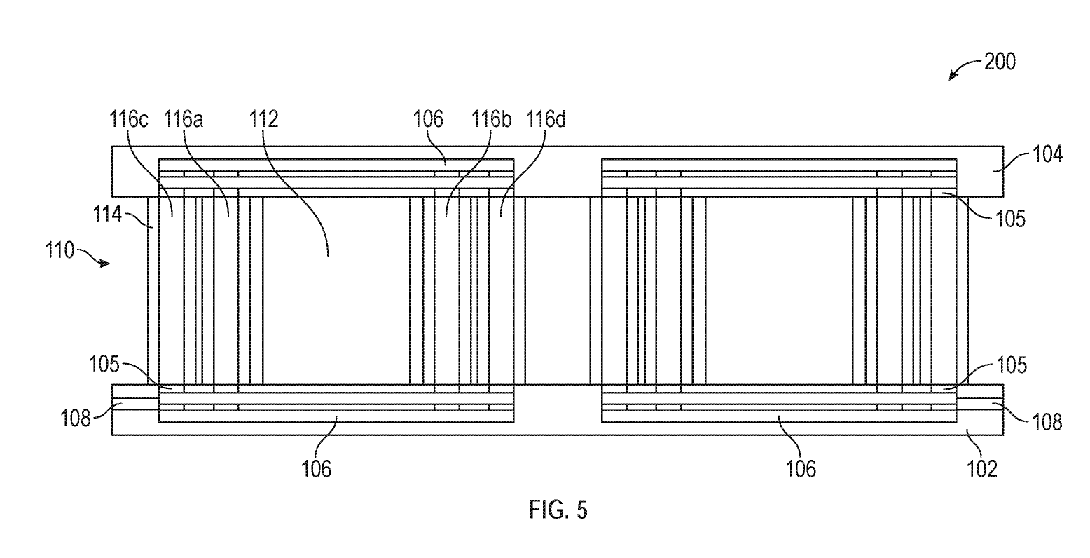

Referring to FIG. 5, in the illustrated embodiment, an electrical device assembly 200 is shown. In the illustrated embodiment, the electrical device assembly 200 is similar to the electrical device assembly 100 described herein, but further includes additional flexible connectors 116c, 116d. In the illustrated embodiment, the additional flexible connectors 116c, 116d can be utilized to provide additional current flow paths or to provide additional current capability. In certain embodiments, the flexible connector 116c can be wired in parallel with the outer flexible connector 116a to provide additional current capability. Similarly, the flexible connector 116d can be wired in parallel with the inner flexible connector 116b. In certain embodiments, the flexible connector 116c can be wired in series with the outer flexible connector 116a to provide additional looping current paths. Similarly, the flexible connector 116d can be wired in series with the inner flexible connector 116b. In other embodiments, the flexible connectors 116c, 116d can be wired in any suitable configuration.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. An electrical device, comprising:
a first flexible connector, including:
a first flexible conductor and a second flexible conductor; and
a flexible insulator disposed between the first flexible conductor and the second flexible conductor;
a second flexible connector spaced apart from the first flexible connector, the second flexible connector including a third flexible conductor;
a first interconnect to electrically connect the first flexible conductor and the third flexible conductor; and
a second interconnect to electrically connect the third flexible conductor and the second flexible conductor, wherein the second interconnect is disposed opposite the first interconnect.

2. The electrical device of claim 1, wherein the first interconnect includes a contact pad.

3. The electrical device of claim 2, wherein the contact pad is aligned with the first flexible conductor to electrically connect the first flexible conductor with the first interconnect.

4. The electrical device of claim 1, wherein the first interconnect is electrically connected to an input/output trace.

5. The electrical device of claim 1, wherein the first interconnect is disposed within a first printed wiring board.

6. The electrical device of claim 1, wherein the second interconnect is disposed within a second printed wiring board.

7. The electrical device of claim 1, wherein the first flexible connector is a unitary connector.

8. The electrical device of claim 1, wherein the first flexible connector and the second flexible connector form a toroid.

9. The electrical device of claim 1, wherein a core is disposed between the first flexible connector and the second flexible connector.

10. The electrical device of claim 1, further comprising an insulation barrier disposed adjacent to the first flexible connector.

11. The electrical device of claim 1, further comprising:
a third flexible connector disposed adjacent to the first flexible connector, wherein the third flexible connector is electrically connected to the first flexible connector.

12. The electrical device of claim 1, further comprising:
a fourth flexible connector disposed adjacent to the second flexible connector, wherein the fourth flexible connector is electrically connected to the second flexible connector.

13. The electrical device of claim 1, wherein the electrical device is an inductor.

14. The electrical device of claim 1, wherein the electrical device is a transformer.

15. An electrical device, comprising:
a first printed wiring board including a first interconnect;
a second printed wiring board including a second interconnect;
a first flexible connector disposed between the first printed wiring board and the second printed wiring board, the first flexible connector including:
a first flexible conductor and a second flexible conductor;
a flexible insulator disposed between the first flexible conductor and the second flexible conductor; and
a second flexible connector spaced apart from the first flexible connector and disposed between the first printed wiring board and the second printed wiring board, the second flexible connector including a third flexible conductor;
wherein the first interconnect electrically connects the first flexible conductor and the third flexible conductor, and the second interconnect electrically connects the third flexible conductor and the second flexible conductor, wherein the second interconnect is disposed opposite the first interconnect.

16. The electrical device of claim 15, wherein the first interconnect includes a contact pad disposed on the first printed wiring board.

17. The electrical device of claim 16, wherein the contact pad is aligned with the first flexible conductor to electrically connect the first flexible conductor with the first interconnect.

18. The electrical device of claim 15, wherein the first interconnect is electrically connected to an input/output trace disposed on the first printed wiring board.

19. The electrical device of claim 15, further comprising:
a third flexible connector disposed adjacent to the first flexible connector and between the first printed wiring board and the second printed wiring board, wherein the third flexible connector is electrically connected to the first flexible connector.

20. The electrical device of claim 19, further comprising:
a fourth flexible connector disposed adjacent to the second flexible connector and between the first printed wiring board and the second printed wiring board, wherein the fourth flexible connector is electrically connected to the second flexible connector.
